(19) United States
(12) Patent Application Publication
(10) Pub. No.: US 2016/0082874 A1
(43) Pub. Date: Mar. 24, 2016

(54) SEED TENDER HYDRAULIC LOAD UNLOAD

(71) Applicant: Unverferth Manufacturing Company, Kalida, OH (US)

(72) Inventor: Brian PETERSON, Ottawa, OH (US)

(73) Assignee: Unverferth Manufacturing Company, Kalida, OH (US)

(21) Appl. No.: 14/469,376

(22) Filed: Aug. 26, 2014

Related U.S. Application Data
(60) Provisional application No. 61/872,084, filed on Aug. 30, 2013.

(51) Int. Cl. B60P 1/00

(52) U.S. Cl. CPC B60P 1/00

(57) ABSTRACT

A system and method for supporting a conveyor of a seed tender so that it can be more easily repositioned between unloading and loading positions. The conveyor may be supported by a coupling that includes a motor. The motor may engage a sprocket or gear to assist the conveyor in moving between the unloading and loading positions. Thus, an operator may move the conveyor to a desired position with less effort.

### BACKGROUND OF THE INVENTION

1. Field of the invention

The present invention relates to seed tenders with repositionable conveyors. In particular, the present invention relates to seed tenders with conveyors repositionable between an unloading position in which the conveyor is capable of unloading material from a hopper on the seed tender and a loading position in which the conveyor is capable of loading material into the hopper.

2. Description of Related Art

It is desirable for a seed tender to have a conveyor that is repositionable between an unloading position and a loading position, e.g., as disclosed in commonly-owned U.S. Pat. No. 8,221,047, the disclosure of which is incorporated herein by reference. One way of facilitating repositioning of a conveyor is to mount the conveyor such that it can be rotated about a vertical axis of rotation. Such a design allows the intake end of the conveyor to be rotated out from under the seed tender tank to a position away from the seed tender such that the discharge end of the conveyor can be located over the seed tender tank. This allows the one conveyor to be used for both loading seed into the seed tender, and then unloading seed from the seed tender into a planter or other vehicle. One way of rotating this conveyor is to manually lift and rotate the conveyor. The conveyor is balanced near its center of gravity so as to minimize the effort required to do this. However, as conveyors get larger and farmers demand more convenience, there is a desire to provide alternative ways of repositioning the conveyor between unloading and loading positions.

### SUMMARY OF THE INVENTION

The present invention provides a system and method for supporting the conveyor of a seed tender so that it can be more easily repositioned between unloading and loading positions. The conveyor may be supported by a coupling that includes a motor. The motor may engage a sprocket or gear to assist the conveyor in moving between the unloading and loading positions. Thus, an operator may move the conveyor to a desired position with less effort.

### BRIEF DESCRIPTION OF THE DRAWINGS

FIG. 1 illustrates a perspective view of a seed tender with a conveyor that is repositionable in which the conveyor is in an unloading position according to an embodiment of the present invention.

FIG. 2 illustrates a perspective view of a seed tender with a conveyor that is repositionable in which the conveyor is being repositioned from an unloading position to a loading position according to an embodiment of the present invention.

FIG. 3 illustrates a perspective view of a seed tender with a conveyor that is repositionable in which the conveyor is in a loading position according to an embodiment of the present invention.

FIG. 4 illustrates an exploded view of the powered coupling for a conveyor according to an embodiment of the present invention.

### DETAILED DESCRIPTION

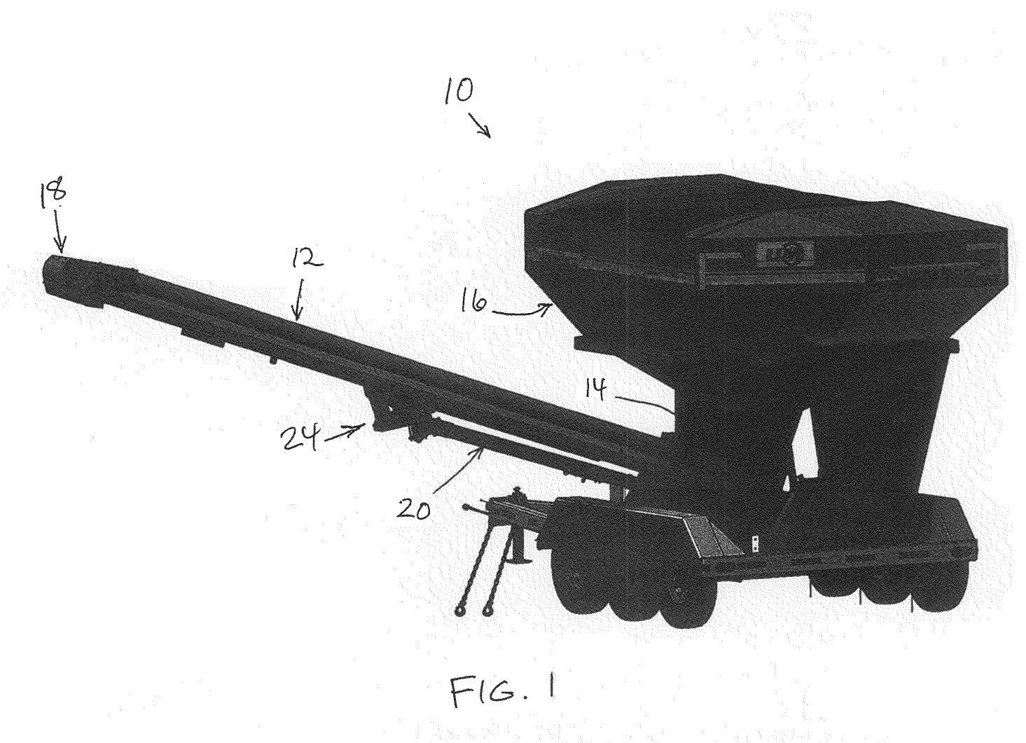

FIG. 1 shows a seed tender 10 with a repositionable conveyor 12 according to an embodiment of the present invention, In this Figure, the conveyor 12 is shown in an unloading position in which an intake 14 at the lower end of the conveyor 12 is located under the main hopper 16 for to receive seed from the seed tender and a discharge 18 at an upper end of the conveyor is positioned to discharge the seed into a planter (not shown). The conveyor 12 is mounted on a support arm 20 that extends upwardly and outwardly from a support structure under the main hopper 16, The conveyor 12 is mounted for rotation about an upper end of the support arm 20.

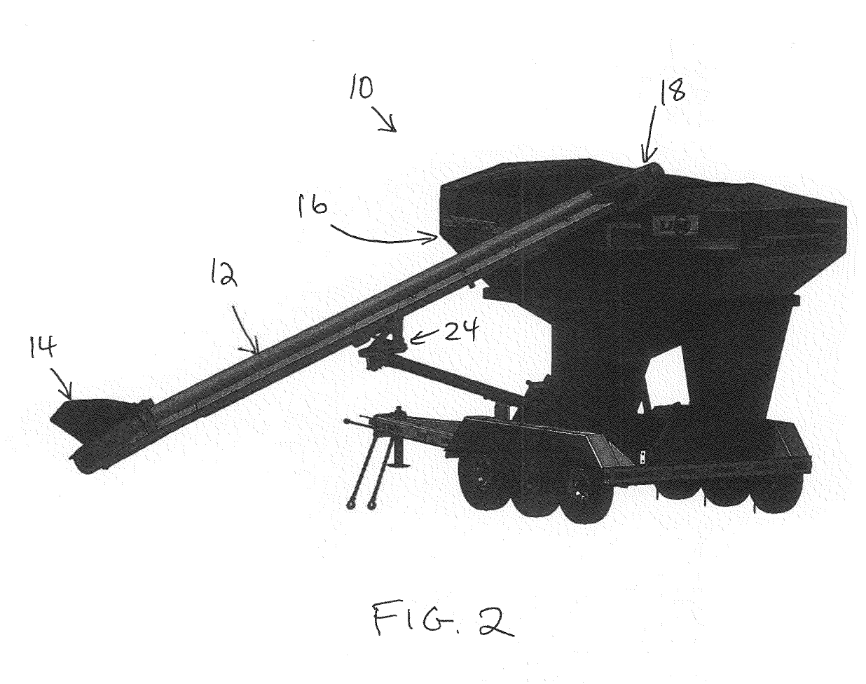

FIG. 2 shows the conveyor 12 in an intermediate position between the unloading and loading positions as it is rotated.

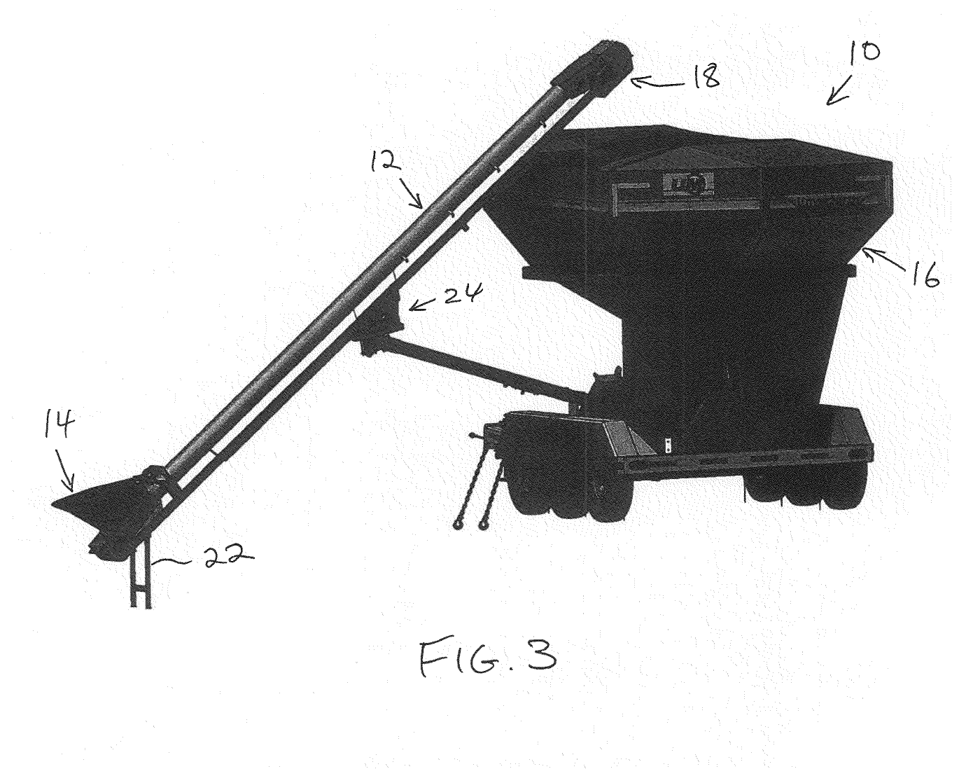

FIG. 3 shows the conveyor 12 in a loading position such that the discharge end 18 of the conveyor is located over the main hopper 16, and the intake end 14 is located either on the ground, or on a stand 22 suspending the intake above the ground. This position allows seed to be loaded into the main hopper.

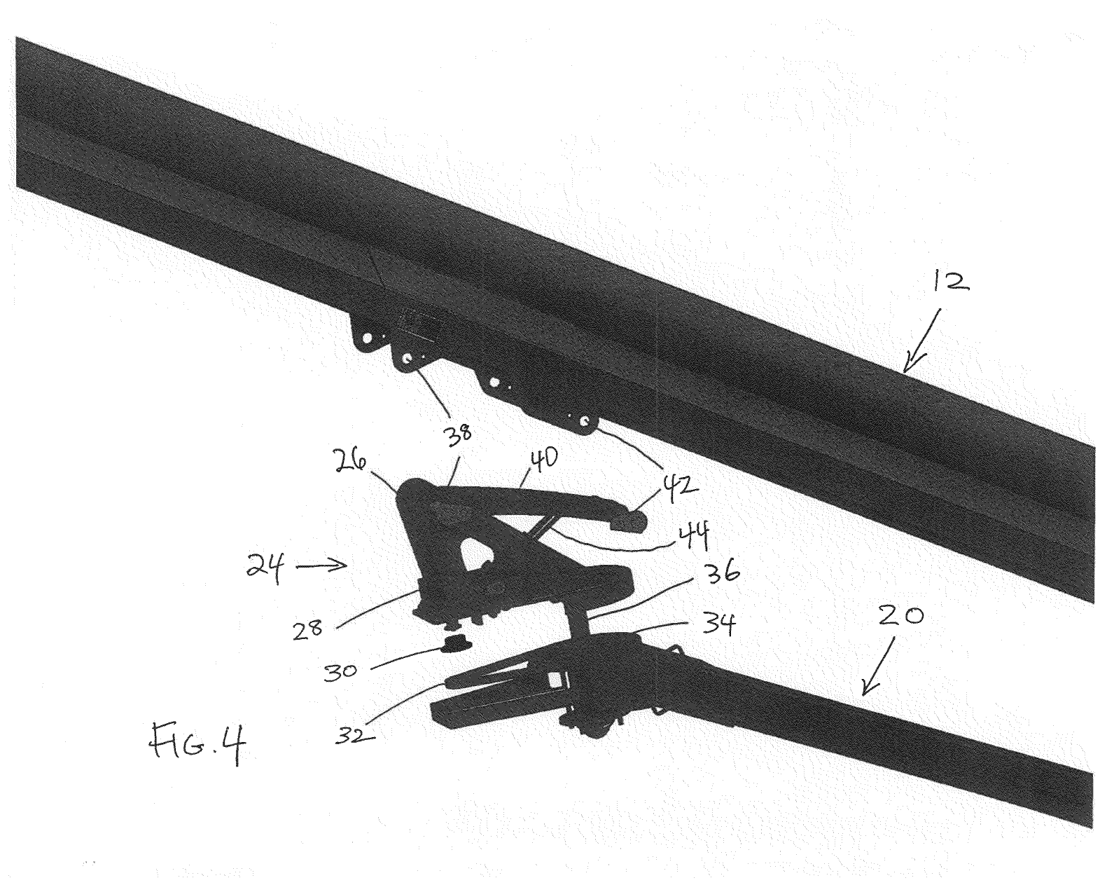

FIG. 4 shows an embodiment of a powered coupling 24 for rotating a conveyor 12 about the upper end of a support arm 20 between unloading and loading positions in accordance with the present invention, The powered coupling 24 includes a bracket 26 connected between the conveyor 12 and the support arm 20. A motor 28 (e.g., a hydraulic motor) is mounted on the bracket and used to rotate a first sprocket 30. First sprocket 30 drives a second, larger sprocket 34 via a drive chain 32. A rotary drive shaft 36 extends upwardly from the second sprocket 34 and is fixed to the bracket 26 to cause the bracket to rotatable by operation of the motor 28. The motor 28 moves the conveyor about a generally vertical axis. It is preferable the axis of rotation is vertical, however the axis of rotation may be tilted from vertical by several degrees.

Referring still to FIG. 4, it can be seen that bracket 26 can be pivotally connected to conveyor 12 at a first location by a horizontal pin 38 to permit pivoting movement of the conveyor about the bracket so that opposite ends of the conveyor can be moved upwardly and downwardly when positioning the conveyor. A lifting member 40 pivotally connected between the pin 38 on bracket 26 and a second location on conveyor 12 where it is connected by a second horizontal pin 42. A lifter 44, such as a hydraulic cylinder, extends upwardly at an angle from the bracket 26 to the lifting member 40 in order to support and It the conveyor 12 via the lifting member 40, e.g., as the conveyor is rotated.

Controls on the seed tender and/or in the cab of a tow vehicle avow the operator to reposition the conveyor back and forth between the unloading and loading positions without having to manually adjust the conveyor. The controls may be wired or wireless control switches. In a preferred embodiment, the controls are electric over hydraulic.

We claim:

1. A seed tender including a hopper configured to store material and including a discharge opening and input opening, comprising:
a conveyor including a receiving end and a discharge end;
a support member to support the conveyor; and
a power coupling to couple the conveyor to the support arm, wherein the power coupling includes a motor,
wherein the conveyor is moveable between a loading position in which the receiving end of the conveyor is positioned under the hopper discharge opening to receive material from the hopper and an unloading position in which the discharge end of the conveyor is positioned to discharge material in the input opening of the hopper, and
wherein the motor of the power coupling moves the conveyor between the loading position and the unloading position.

2. The seed tender according to claim 1, wherein the power coupling includes a first sprocket, and the motor engages the first sprocket to move the conveyor.

3. The seed tender according to claim 2, wherein the power coupling includes a second sprocket and a drive chain, and the first sprocket engages the second sprocket via the drive chain and the second sprocket moves the conveyor.

4. The seed tender according to claim 1, further comprising a controller to control the motor of the power coupling.

5. The seed tender according to claim 1, further comprising a lifting member configured to move the conveyor about a tilt axis.

6. The seed tender according to claim 5, wherein the tilt axis is generally horizontal.

7. The seed tender according to claim 1, wherein the support arm including a first end coupled to the seed tender and a second end, and the power coupling is coupled to the second end of the support arm.

8. The seed tender according to claim 1, wherein the motor rotates the conveyor about a generally vertical axis.
